(19) United States
(12) Patent Application Publication
(10) Pub. No.: US 2009/0320351 A1
(43) Pub. Date: Dec. 31, 2009

(54) Waterfowl decoy apparatus

(76) Inventor: Rubik Darian, Glendale, CA (US)

Correspondence Address: JAMES E. BRUNTON, ESQ., P. O. BOX 29000, GLENDALE, CA, 91209, US

(21) Appl. No.: 12/217,006

(22) Filed: Jun. 30, 2008

(51) Int. Cl. A01M 31/06

(52) U.S. Cl. 43/3; 43/2

(57) ABSTRACT

A waterfowl decoy apparatus to attract over flying waterfowl to an array of waterfowl replicas placed on the surface of a field or on the surface of a body of water. The apparatus includes a generally disk-shaped housing having top, bottom and side walls that cooperate to define an interior chamber. The top wall of the housing is uniquely provided with a plurality of spaced-apart sets of curved windows. Disposed beneath each window of each set of windows is at least one small light bulb, or globe. The light bulbs, which are powered by a dry cell battery disposed within the internal chamber, are controllably lighted in a predetermined fashion by a control circuit that is also disposed within the internal chamber to simulate the flapping of wings.

### BACKGROUND OF THE INVENTION

1. Field of the Invention

The present invention relates generally to decoys used in attracting waterfowl. More particularly, the invention concerns a novel waterfowl decoy apparatus for use in attracting the attention of over flying waterfowl.

2. Discussion of the Prior Art

The use of decoys of various designs and configurations is known in the prior art. More particularly, a number of different types of decoys have been used in the past to attract various animals. Perhaps the best known prior art decoy is the duck decoy, which traditionally takes the form of a replica of a duck that functions to attract over flying ducks. Typically, the decoys are made of wood, plastic and other materials and are designed to float on water, or, alternatively, for use in a field.

To attract waterfowl, hunters typically place a plurality of decoys on the surface of a body of water or in a field that is adjacent to the hunters' blind. Waterfowl flying over the decoys become less hesitant to light if they see one of their own, or at least what they perceive to be one of their own, resting in the water or in the field.

Exemplary of prior art decoy systems is the system disclosed in U.S. Pat. No. 6,782,653 issued to Thomas. The Thomas patent concerns a system that includes a plurality of decoy pennants attached to a decoy line. A plurality of decoy lines joined in series form a decoy line train. Opposite ends of each decoy line include a snap swivel for preventing the pennants and decoy line from becoming tangled. A portion of the decoy line is attached to a top of a line pole for suspending the decoy pennants above a ground surface or a water surface. Also, a portion of the decoy line can be connected to a decoy line animator for moving the decoy line and pennants from one position to another. The decoy system also includes a backpack or dolly with a vertical hand-operated vertical spool for holding the pennants and decoy lines thereon and transporting the decoy system to and from the hunting area.

Another prior art decoy system is disclosed in U.S. Pat. No. 6,212,816 issued to Babbitt. The Babbitt system relates to a remote controlled animated bird decoy that includes a body and an oscillating mechanism to simulate horizontal life-like movements. The oscillating mechanism oscillates the bird decoy body and includes a battery-operated motor which is remote controlled. A sensory device with memory programmed to provide oscillatory motion is connected to the motor which provides, in turn, horizontal oscillatory motion of the bird decoy body so that the body oscillates in a horizontal plane in relation to the ground surface, simulating a turning movement of a live bird.

While the prior art devices described in the preceding paragraph are generally representative of prior art decoy devices, the aforementioned patents do not suggest or describe a duck hunting decoy apparatus that is remotely similar to the novel decoy apparatus of the present invention.

### SUMMARY OF THE INVENTION

By way of brief summary, the decoy apparatus of one form of the present invention comprises a generally disk-shaped housing having a top, bottom and side wall that cooperate to define an interior chamber. The top wall of the housing is uniquely provided with a plurality of spaced-apart pairs of curved windows. Disposed beneath each window of each pair of windows is at least one small light bulb, or globe. The light bulbs, which are powered by a dry cell battery disposed within the internal chamber, are controllably lighted in a sequential fashion by a control circuit that is also disposed within the internal chamber.

In use, the apparatus of the invention is located proximate the center of a plurality of conventional decoys that are positioned either on a body of water or on the field. Sequential lighting of the windows of the centrally located apparatus will attract the attention of over flying ducks to the decoys that surround the apparatus, thereby encouraging the ducks to land.

With the forgoing summary in mind, it is an object of the present invention to provide a new and improved duck hunting decoy apparatus that includes a housing having an interior chamber for containing a plurality of small light globes that are controllably lighted in a predetermined fashion by a control circuit that is also disposed within the internal chamber of the housing.

Another object of the invention is to provide a new and improved duck hunting decoy apparatus of the aforementioned character that uses a conventional dry cell battery that is located within the interior chamber of the housing to illuminate the plurality of small light globes in a predetermined fashion.

Another object of the invention is to provide a new and improved duck hunting decoy apparatus of the character described that further includes an electric circuit that is operably associated with the dry cell battery and the light globes and is adapted to illuminate the light globes in a predetermined fashion.

Another object of the invention is to provide a new and improved decoy apparatus that effectively attracts numerous types of wild birds, but is particularly well suited as a decoy apparatus for attracting ducks.

Another object of the invention is to provide a new and improved duck hunting decoy apparatus as described in the preceding paragraphs that is of a compact construction that is easy to transport and store.

Another object of the invention is to provide a new and improved duck hunting decoy apparatus of the class described that is of a simple construction that can be easily and efficiently manufactured and marketed.

Another object of the invention is to provide a new and improved duck hunting decoy apparatus that is of a durable and reliable construction.

The forgoing, as well as other objects of the invention will be realized by the novel decoy apparatus illustrated in the drawings and described in the paragraphs which follow.

### BRIEF DESCRIPTION OF THE DRAWINGS

FIG. 1 is a generally perspective, diagrammatic view illustrating one form of the use of the apparatus of the present invention for attracting ducks.

FIG. 2 is a generally perspective, exploded view of the waterfowl decoy apparatus showing the arrangement of the light bulbs that illuminate the windows provided in the top wall of the apparatus.

FIG. 3 is an enlarged generally perspective exploded view of the waterfowl decoy apparatus illustrated in FIG. 2.

FIG. 4 is an enlarged, cross-sectional view taken along lines 4-4 of FIG. 2.

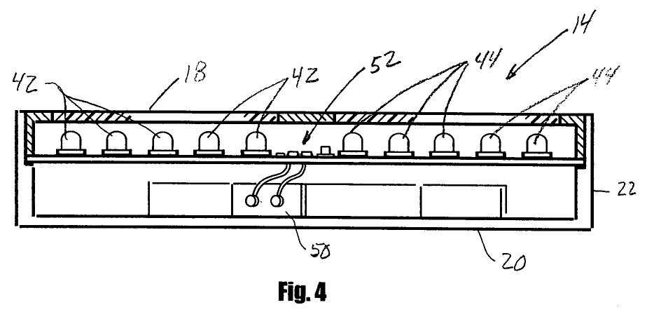

### DESCRIPTION OF THE INVENTION

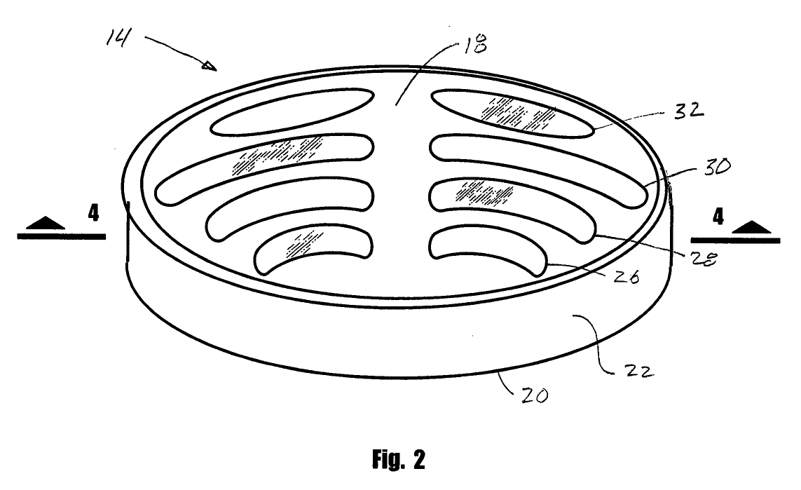

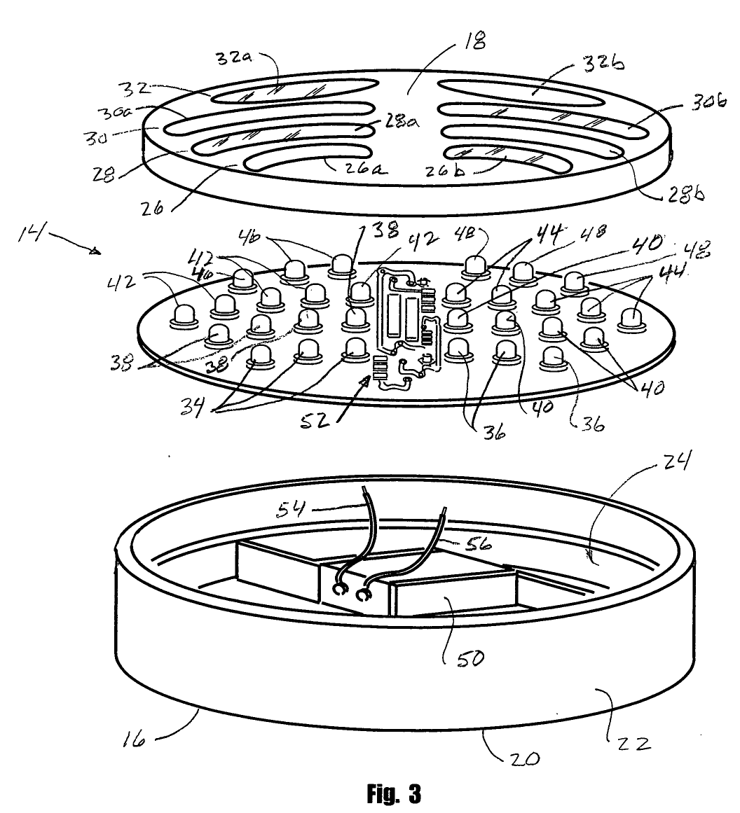

Referring to the drawings and particularly FIGS. 2 and 3, one form of the waterfowl decoy apparatus of the invention is there shown in generally identified by the numeral 14. Apparatus 14 here comprises a generally disk shaped housing 16 having a top wall 18, a bottom wall 20 and a side wall 22 that connects the top and bottom wall in a manner to define an interior chamber 24. As previously mentioned, the apparatus of the invention is uniquely designed to attract the attention of over flying waterfowl to a plurality of waterfowl replicas that are placed on the surface of a field or on a water surface.

As illustrated in the drawings, top wall 18 is provided with first, second, third and fourth sets of spaced apart, differently shaped curved windows 26, 28, 30 and 32 respectively. For a reason presently to be described, each of the windows of windows set 30 is longer and less curved than are each of the windows of windows set 28. Similarly, each of the windows of windows set 28 is longer and less curved than are each of the windows of windows set 26. As best seen in FIG. 2 of the drawings, each of the windows of windows set 32 is generally oval-shaped.

Disposed within interior chamber 24 and located directly beneath window 26a of the curved windows set 26 is a first light source, shown here as a three small light bulbs 34. In similar fashion, a second light source, shown here as three small light bulbs 36, is located directly beneath the second window 26b of curved windows set 26. A third light source, shown here as four small light bulbs 38 is located directly beneath the first window 28a of the curved windows set 28, while a fourth light source, shown here as four small light bulbs 40, is located directly beneath the second window 28b of the curved windows set 28. In similar fashion, a fifth light source, shown here as five small light bulbs 42, is located directly beneath the third window 30a of the curved windows set 26. A sixth light source, shown here as five small light bulbs 44 is located directly beneath the second window 30b of the curved windows set 30. A seventh light source, shown here as three small light bulbs 46 is located directly beneath the first window 32a of the curved windows set 32, while an eighth light source, shown here as three small light bulbs 48, is located directly beneath the second window 32b of the curved windows set 32. Light bulbs 34, 36, 38, 40, 42, 44, 46, and 48 can be any type of readily commercially available light bulbs, including incandescent light bulbs, but preferably take the form of conventional light emitting diodes (LEDs).

Forming an important aspect of the waterfowl decoy apparatus of the present invention is the provision of a light source illuminating means that is disposed within interior chamber 24 of housing and functions to intermittently illuminate the eight previously described light sources of the apparatus. More particularly, the light source illuminating means is specially designed to illuminate the light sources in a manner to sequentially eliminate the four sets of windows. By way of example, the light source illuminating means first illuminates and then shuts off the first and second light sources, next the third and fourth light sources are illuminated and shut off, then the fifth and sixth light sources are illuminated and shut off and finally the seventh and eighth light sources are illuminated and shut off. As will be further described hereinafter, this novel sequential lighting of the window sets simulates the flapping of the wings of the waterfowl and effectively captures the attention of over flying waterfowl.

As been seen in FIG. 3 of the drawings, the light source illuminating means of the embodiment of the invention there shown comprises a conventional, readily commercially available dry cell battery 50 that is disposed within internal chamber 24 and an electric circuit, shown here as a circuit board 52 that is also disposed within said internal chamber 24. Battery 50 is interconnected with circuit board 52 in a conventional manner well understood by those skilled in the art by connector wires 54 and 56. Similarly, the design of circuit board 52 to accomplish the sequential lighting of the window sets in the manner discussed in the preceding paragraph is well understood by those skilled in the art and need not be discussed in detail herein.

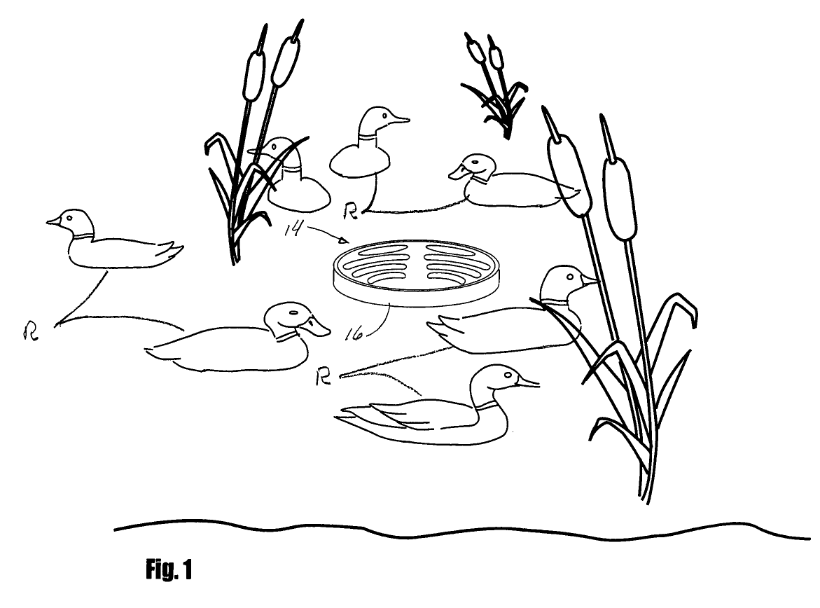

In using the apparatus of the invention and in accordance with one form of the method of the invention, a plurality of waterfowl replicas “R” are first placed on the surface of the target area in the manner shown in FIG. 1 of the drawings. With the replicas “R” in place, the waterfowl decoy apparatus 14 is positioned amidst the replicas as illustrated in FIG. 1. This done, using the illumination means of the invention, the spaced apart window sets are sequentially illuminated. More particularly, to simulate the flapping of the wings of a waterfowl, the light source illuminating means is used to first illuminate and then shut off the first and second light sources. Next the third and fourth light sources are illuminated and shut off and then the fifth and sixth light sources are illuminated and shut off. Finally the seventh and eighth light sources are illuminated and shut off. This simulated flapping of the wings of the waterfowl uniquely captures the attention of over flying waterfowl, thereby drawing their attention to the replicas “R”, making them more inclined to light among the replicas.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A waterfowl decoy apparatus for attracting the attention of over flying waterfowl to waterfowl replicas that are placed on a surface, said apparatus comprising:
(a) a housing having an interior chamber, said housing including a top wall having a plurality of spaced apart windows provided therein;
(b) a plurality of light sources disposed within said interior chamber of said housing for illuminating said spaced apart windows; and
(c) light source illuminating means disposed within said interior chamber of said housing for controllably illuminating said plurality of light sources.

2. The waterfowl decoy apparatus as defined in claim 1 in which each window of said plurality of spaced apart windows is curved.

3. The waterfowl decoy apparatus as defined in claim 1 in which light source illuminating means comprises a dry cell battery disposed within said internal chamber of said housing and an electric circuit disposed within said internal chamber of said housing for interconnecting said dry cell battery with said plurality of light sources.

4. The waterfowl decoy apparatus as defined in claim 1 in which each of said first, second, third and fourth light sources comprises a light bulb.

5. A waterfowl decoy apparatus for attracting the attention of over flying waterfowl to waterfowl replicas that are placed on the surface of a field or on a water surface, said apparatus comprising:
(a) a housing having an interior chamber, said housing including a top wall having first, second, third and fourth spaced apart curved windows provided therein;
(b) a first light source disposed within said interior chamber beneath said first curved window;
(c) a second light source disposed within said interior chamber beneath said second curved windows;
(d) a third light source disposed within said interior chamber beneath said third curved window;
(e) a fourth light source disposed within said interior chamber beneath said fourth curved window; and
(f) light source illuminating means disposed within said interior chamber of said housing for illuminating said first, second, third and fourth light sources.

6. The waterfowl decoy apparatus as defined in claim 5 in which said third and fourth windows are larger than and are of a greater curvature than said first and second curved windows.

7. The waterfowl decoy apparatus as defined in claim 5 in which light source illuminating means comprises a dry cell battery disposed within said internal chamber of said housing and an electric circuit disposed within said internal chamber of said housing for interconnecting said dry cell battery with said first, second, third and fourth light sources.

8. The waterfowl decoy apparatus as defined in claim 5 in which each of said first, second, third and fourth light sources comprises a plurality of light bulbs.

9. The waterfowl decoy apparatus as defined in claim 5 in which each of said first, second, third and fourth light sources comprises a plurality of light emitting diodes.

10. A waterfowl decoy apparatus for attracting the attention of over flying waterfowl to waterfowl replicas that are placed on a water surface, said apparatus comprising:
(a) a housing having an interior chamber, said housing including a top wall having a first set of windows comprising spaced apart first and second curved windows of a first size and a second set of windows comprising spaced apart third and fourth curved windows of a second size provided therein;
(b) a first light source disposed within said interior chamber beneath said first curved window;
(c) a second light source disposed within said interior chamber beneath said second curved windows;
(d) a third light source disposed within said interior chamber beneath said third curved window;
(e) a fourth light source disposed within said interior chamber beneath said fourth curved window; and
(f) light source illuminating means disposed within said interior chamber of said housing for illuminating said first, second, third and fourth light sources to sequentially illuminate said first and second sets of windows.

11. The waterfowl decoy apparatus as defined in claim 10 in which light source illuminating means comprises a dry cell battery disposed within said internal chamber of said housing and an electric circuit disposed within said internal chamber of said housing for interconnecting said dry cell battery with said first, second, third and fourth light sources.

12. The waterfowl decoy apparatus as defined in claim 11 in which each of said first, second, third and fourth light sources comprises a plurality of light emitting diodes.

13. A method of hunting waterfowl using a plurality of waterfowl replicas that are placed on the surface of the target area and a waterfowl decoy apparatus comprising a housing having an interior chamber, a top wall having a first set of windows comprising spaced apart first and second curved windows of a first size and a second set of windows comprising spaced apart third and fourth curved windows of a second size provided therein, light sources disposed within the interior chamber beneath the first and second sets of windows and illumination means for illuminating the light sources, the method comprising the steps of placing the water fowl decoy apparatus amidst the waterfowl replicas and using the illumination means intermittently illuminating the light sources.

14. The method as defined in claim 13 in which, using the said illumination means, illuminating the light sources to sequentially illuminate said first and second sets of windows.
